(19) United States
(12) Patent Application Publication
(10) Pub. No.: US 2025/0303790 A1
(43) Pub. Date: Oct. 2, 2025

(54) WHEEL AND VEHICLE INCLUDING THE SAME

(71) Applicants: HYUNDAI MOTOR COMPANY, SEOUL (KR); KIA CORPORATION, SEOUL (KR)

(72) Inventors: Ju Ho Kim, Suwon-si (KR); Eun Sik Kim, Gwangmyeong-si (KR)

(73) Assignees: HYUNDAI MOTOR COMPANY, SEOUL (KR); KIA CORPORATION, SEOUL (KR)

(21) Appl. No.: 18/904,759

(22) Filed: Oct. 2, 2024

(30) Foreign Application Priority Data
Mar. 27, 2024 (KR) 10-2024-0041621

(51) Int. Cl. B60B 21/12

(52) U.S. Cl. CPC B60B 21/12

(57) ABSTRACT

A vehicle wheel includes a wheel disk including a hub configured to be coupled to an axle, spokes extending radially from the hub, and a wheel rim provided on a radially outward side of the spokes. The vehicle wheel further includes a plurality of sliders provided on the spokes and moving in a radial direction to adjust opening and closing of openings. Additionally, the vehicle wheel includes a driving unit moving the sliders in a radial direction. The driving unit includes a pusher moving in a thickness direction of the wheel disk, perpendicular to the radial direction, a moving direction of the sliders.

### CROSS REFERENCE TO RELATED APPLICATIONS

This application claims benefit of priority to Korean Patent Application No. 10-2024-0041621 filed on Mar. 27, 2024 in the Korean Intellectual Property Office, the disclosure of which is incorporated herein by reference in its entirety.

### BACKGROUND

### 1. Field

The present disclosure relates to a vehicle wheel and a vehicle including the same.

### 2. Description of Related Art

In general, the wheels of a vehicle are provided to be connected to an axle, and tires in contact with the ground are installed on the wheels. Wheels are important in terms of design, but they also have a major impact on the vehicle's aerodynamic performance and brake disc performance.

Meanwhile, in order to improve the fuel efficiency of vehicles, it is desirable to reduce air resistance acting on a vehicle driving at high speed. It is known that the top/bottom shape of vehicles contributes to about 65% of air resistance, wheels/tires contribute to about 25% of air resistance, while cooling resistance contributes to about 10% of air resistance.

Many global vehicle manufacturers have been conducting research on the tops and bottoms of vehicles for decades, and various air resistance improvement technologies have been developed and applied to actual mass-production. However, the development of air resistance improvement technology for wheels/tires that rotate at relatively high speeds has only recently progressed at full-scale.

A wheel includes a wheel rim and a wheel disk, and air resistance tends to improve as openings between spokes of the wheel disk are blocked (i.e., as an aperture ratio decreases). However, if the aperture ratio is too low, air does not pass therethrough easily, making it difficult to sufficiently cool heat generated by a brake disc, and thus, the aperture ratio cannot be lowered unconditionally to improve aerodynamics.

To improve this, technology has recently been developed which may satisfy both braking and aerodynamic performance by applying a device which may actively open or close the openings between the spokes.

However, the related art device for opening and closing the openings between spokes may be insufficient in terms of structure and efficiency, and furthermore, it may be difficult to install a driving device inside a wheel rotating at high speeds and it may be difficult to stably supply power to the driving device.

### SUMMARY

An object of the present disclosure is to solve at least some of the above problems, and to provide a structure of an opening and closing device capable of efficiently opening and closing an opening between spokes with a simple structure.

The object of the present disclosure is not limited to the object mentioned above, and other objects not mentioned will be clearly understood by those skilled in the art from the description below.

According to an aspect of the present disclosure, a vehicle wheel includes a wheel disk including a hub to be coupled to an axle, spokes extending radially from the hub, and a wheel rim provided on a radially outward side of the spokes, a plurality of sliders provided on the spokes and moving in a radial direction to adjust opening and closing of openings, and a driving unit moving the sliders in a radial direction, and wherein the driving unit may include a pusher moving in a thickness direction of the wheel disk, perpendicular to the radial direction, a moving direction of the sliders.

The pusher may be provided in a round ring shape.

The driving unit may include a push ring formed of a shape memory alloy material which is linked to the pusher to provide a driving force for pushing the pusher in a thickness direction.

The pusher may include a ring-shaped groove at an end into which the push ring is inserted.

The driving unit may include an elastic member returning the sliders moved by the push ring to their original positions.

The driving unit may include the pusher moving in the direction of the wheel disk thickness and is linked to the slides, and a push ring formed of shape memory alloy which is linked to the pusher and provides a driving force to push the pusher in the thickness direction.

The vehicle wheel may comprise a thickness portion extending in the thickness direction from a surface of the wheel rim, and wherein a locking protrusion on which the push ring is locked inside the thickness portion is provided.

The surface of the pusher is provided in an inclined cone shape, and the sliders may have a shape in which a surface in contact with the pusher is inclined toward the thickness direction in the radial direction.

A first angle of the first slope, in which the surface of the pusher is inclined with respect to the radial direction, is greater than a second angle of the second slope, in which the surface on which the slider is in contact with the pusher is inclined with respect to the radial direction.

A length of the push ring may increase in the thickness direction when power (current) is applied thereto.

The driving unit may include an elastic member provided between an inner side of the wheel rim and a radial end of the sliders.

The elastic member may be a leaf spring.

A hub protrusion, with which the sliders pushed by the elastic member are locked, may be provided on an inner surface of the hub.

A guide protruding to extend in a radial direction along the edge of the sliders to guide the movement of the sliders may be provided on the inner surface of the spokes.

The sliders may be provided to correspond to the shapes of the openings.

The sliders may have a larger circumferential width than the openings.

According to another aspect of the present disclosure, a vehicle includes a body, and the vehicle wheel according to an exemplary embodiment provided to enable the body to travel.

A disc brake may be provided on the inside of the vehicle wheel, and a radial outer end of the openings is parallel to a radial outer end of the disc brake, or the openings are provided to entirely overlap the disc brake.

The vehicle wheel according to an exemplary embodiment of the present disclosure may easily open or close the openings between spokes using an opening and closing device of a simple structure, thereby improving the aerodynamic performance and fuel efficiency of the vehicle.

The effects of the present disclosure are not limited to those described above, and other effects not mentioned will be clearly recognized by those skilled in the art from the description below.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 and FIG. 2 are perspective views illustrating a vehicle wheel according to an exemplary embodiment of the present disclosure, viewed from the outside (FIG. 1 with openings closed, FIG. 2 with the openings open);

FIG. 3 is an exploded perspective view of a vehicle wheel according to an exemplary embodiment of the present disclosure;

FIG. 4 is a half-cross-sectional perspective view showing the shape of a vehicle wheel viewed from the inside according to an exemplary embodiment of the present disclosure (the openings are in the closed state);

FIG. 5A and FIG. 5B are a cross-sectional view and a plan view in a state in which the openings of a vehicle wheel according to an exemplary embodiment of the present disclosure are closed;

FIG. 6A and FIG. 6B are a cross-sectional view and a plan view in a state in which the openings of a vehicle wheel according to an exemplary embodiment of the present disclosure are opened;

FIG. 7 is a reference diagram illustrating the shapes of a brake disc and a caliper installed on another vehicle wheel according to an exemplary embodiment of the present disclosure;

FIG. 8 is a reference diagram illustrating an example of air flowing along the openings of a vehicle wheel according to an exemplary embodiment of the present disclosure; and

FIG. 9 is a reference diagram illustrating a vehicle to which a vehicle wheel according to an exemplary embodiment of the present disclosure is applied.

### DETAILED DESCRIPTION

While the present disclosure may be modified in various manners and take on various alternative forms, specific embodiments thereof are illustrated in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit, part, portion, etc.” may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In this specification, vehicles refer to a variety of vehicles that move transported objects, such as people, animals, or goods, from a starting point to a destination. These vehicles are not limited to vehicles that run on roads or tracks. In addition, vehicles include not only those that use fossil fuels, such as gasoline, but also those that use electricity stored in batteries or the like and those that use future fuels, such as hydrogen.

In the description below, the terms “anterior,” “posterior,” “lateral,” “front,” “rear,” “up/down,” “above,” “upper,” “top,” “below,” “lower,” “bottom,” “left/right,” and the like are defined based on a vehicle or vehicle body. In addition, terms, such as first and second may be used to describe various components, but these components are not limited in order, size, location, or importance by terms, such as first and second and named for the sole purpose of distinguishing one component from another.

Hereinafter, embodiments of the present disclosure will be described in detail with reference to the accompanying drawings.

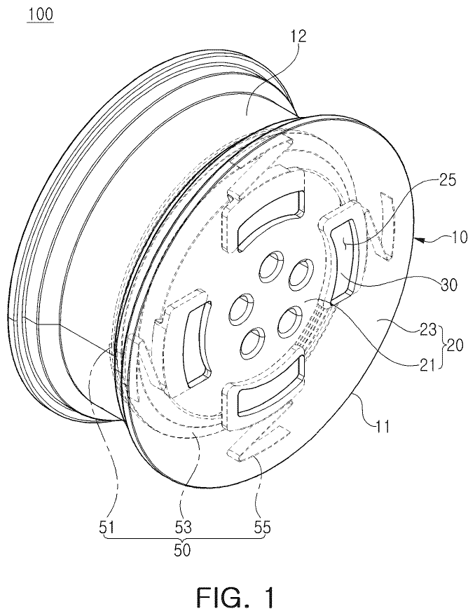

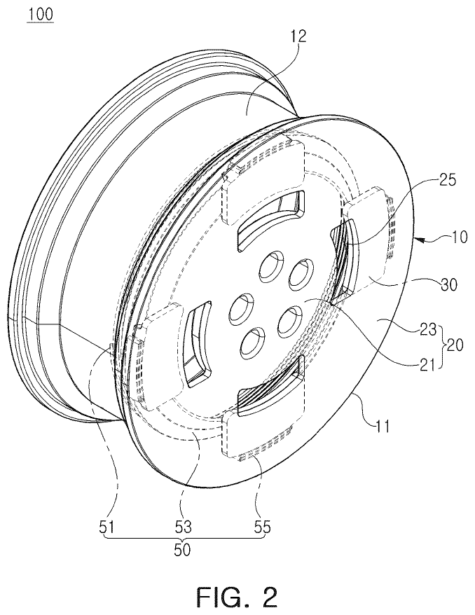

FIG. 1 and FIG. 2 are perspective views illustrating a vehicle wheel according to an exemplary embodiment of the present disclosure, viewed from the outside (FIG. 1 with the openings closed, FIG. 2 with the openings open).

Referring to FIG. 1 and FIG. 2, the vehicle wheel 100 according to an exemplary embodiment of the present disclosure may be connected to an axle of a vehicle, and may be applied to, for example, a wheel/tire assembly of a passenger vehicle. The wheel 100 may basically include a wheel rim 10 and a wheel disk 20.

The wheel rim 10 is a portion on which a tire (not shown in the drawing) is mounted, and has rim flanges 11 on both sides in a width direction of the vehicle. The wheel disk 20 may include a hub 21 coupled to the axle on an inner center side of the wheel rim 10 and a plurality of spokes 23 radially connecting the hub 21 to the rim flange 11. The spokes 23 may be divided into a plurality of pieces or may be provided with a plurality of openings 25 penetrating the surface of the spokes 23 in one piece (for convenience, the latter is illustrated in the drawings).

Here, the wheel disk 20 may include openings 25 provided in the spokes 23.

The openings 25 may have a constant width or may have a width gradually narrowing from the rim flange 11 toward the hub 21. In the drawings of the present embodiment, only the openings 25 having a constant width are illustrated for convenience of illustration, but the shape of the openings 25 is not limited thereto.

Since the basic configuration of the wheel rim 10 and the wheel disk 20 is a well-known technology widely known to those skilled in the art, a detailed description of the configuration will be omitted in this specification.

The vehicle wheel 100 according to an exemplary embodiment of the present disclosure has a structure in which the openings 25 provided in the spokes 23 are opened or closed, and the area of the openings 25 may be variably adjusted by rotation of the sliders 30.

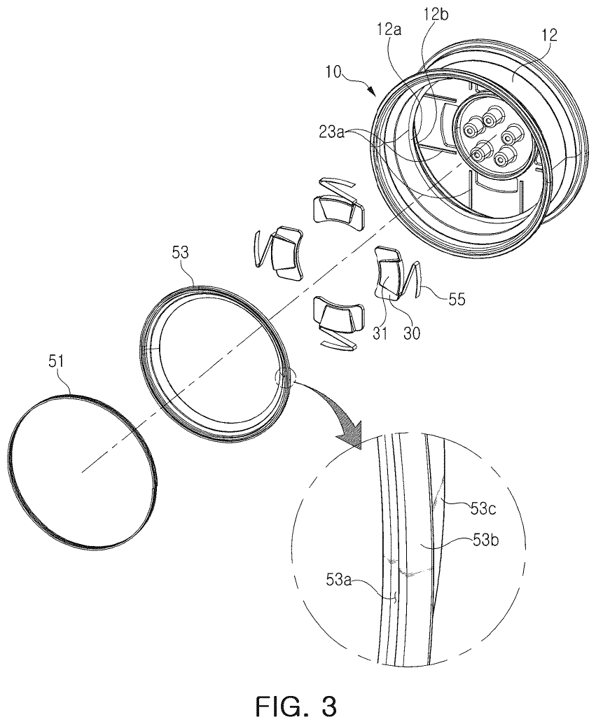

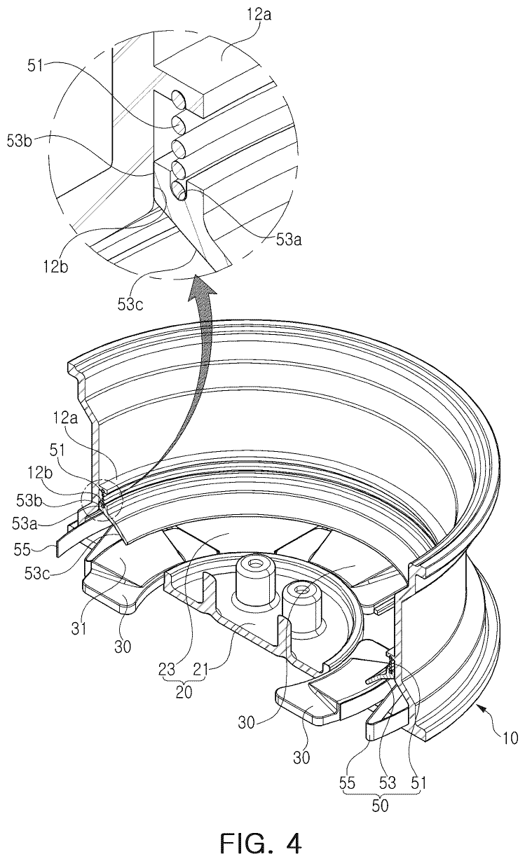

Referring to FIGS. 1 to 6, the vehicle wheel 100 of an exemplary embodiment of the present disclosure may include a plurality of sliders 30 provided on spokes 23 and moved in a radial direction to adjust the opening and closing of the openings 25, so as to enable the openings 25 to be opened or closed.

The sliders 30 of the present embodiment may be installed on the spokes 23.

The sliders 30 may adjust the opening and closing of the openings 25 provided in the spokes 23. The sliders 30 may be driven to move between the hub 21 and the rim flange 11. For example, the sliders 30 may be driven to move linearly between the hub 21 and the rim flange 11.

The sliders 30 may correspond to the shape of the openings 25, and more specifically, the sliders 30 may be provided with a larger circumferential width than the openings 25. Accordingly, the openings 25 can be completely blocked by the sliders 30.

Here, the radial direction may be a direction from the hub 21 to the rim flange 11, the circumferential direction may be a direction in which the vehicle wheel 100 rotates, and the thickness direction may be a direction in which the axle coupled to the vehicle wheel 100 extends.

In detail, the vehicle wheel 100 of the present embodiment includes a wheel disk 20 having a hub 21 to be coupled to the axle, spokes 23 extending radially from the hub 21, and a wheel rim provided on the radially outward side of the spokes 23, a plurality of sliders 30 provided on the spokes 23 and moving in the radial direction to adjust the opening and closing of the openings 25, and a driving unit 50 moving the sliders 30 in the radial direction. For example, the driving unit may linearly move the sliders 30 in the radial direction.

Additionally, the driving unit 50 may include a pusher 53 moving in the thickness direction of the wheel disk 20 perpendicular to the radial direction, which is the moving direction of the sliders 30. The pusher 53 may be provided in a rounded ring shape.

In addition, the driving unit 50 may include a push ring 51 formed of shape memory alloy which is linked to the pusher 53 and provides a driving force to push the pusher 53 in the thickness direction. The pusher 53 may have a ring-shaped groove 53a at an end into which the push ring 51 is inserted.

Additionally, the driving unit 50 may include an elastic member 55 that returns the sliders 30, which has been moved in a straight line by the push ring 51, to their original positions. The elastic member 55 may be a spring, and more specifically, may be a leaf spring.

In other words, in the present embodiment, the driving unit 50 providing the moving power of the sliders 30 may include a pusher 53, a push ring 51, and an elastic member 55.

The push ring 51 can be a source of driving force in the driving unit 50, and various driving devices can be used. For example, the push ring 51 may be formed of a shape memory alloy material whose length is adjusted in the thickness direction by power (current) supply. However, it is not limited thereto and any motor which may provide power can be used.

The pusher 53 may be connected to the push ring 51. When the pusher 53 moves in the thickness direction, the openings 25 may be opened. As an example, when the length of the push ring 51 extends in the thickness direction by power (current) supply, the pusher 53 may move in the thickness direction of the wheel disk 20, and accordingly, the openings 25 may be opened as the sliders 30 linked to the pusher 53 move in the radial direction.

The pusher 53 may be slidably moved while in contact with the inner surface of the wheel rim 10, more specifically, the thickness portion 12 thereof. Accordingly, the pusher 53 may be provided with a first straight portion 53b parallel to the thickness direction at a portion in contact with the inner surface of the thickness portion 12. In addition, the inner surface of the thickness portion 12 may be provided with a second straight portion 12b through which the first straight portion 53b may be slidably moved.

Here, the push ring 51 moves in the thickness direction, and the sliders 30 linked to the push ring 51 may move in the radial direction perpendicular to the thickness direction. For this purpose, the pusher 53 is provided in the shape of an inclined cone, and accordingly the surface of the pusher 53 has an inclined shape, and the sliders 30 may have a shape in which the surface of the sliders 30 in contact with the pusher 53 is inclined toward the thickness direction in the radial direction.

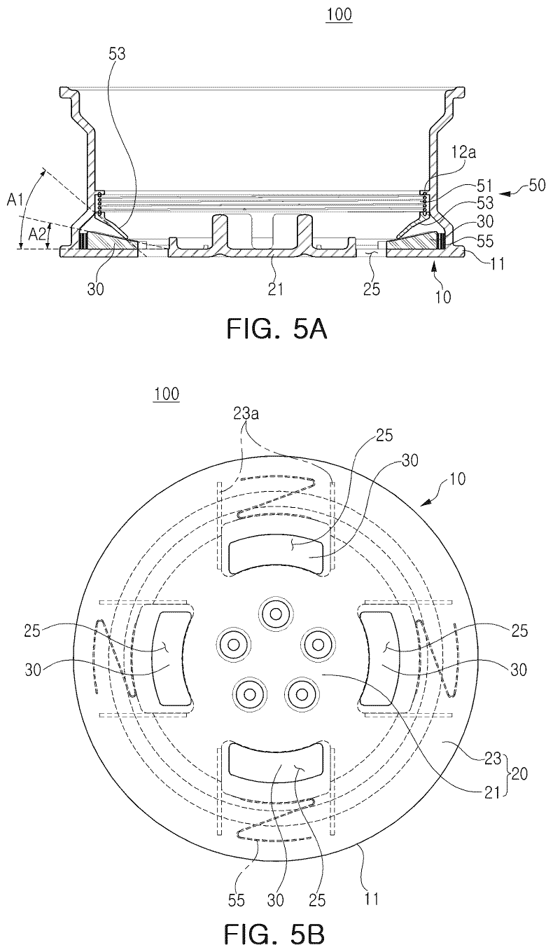

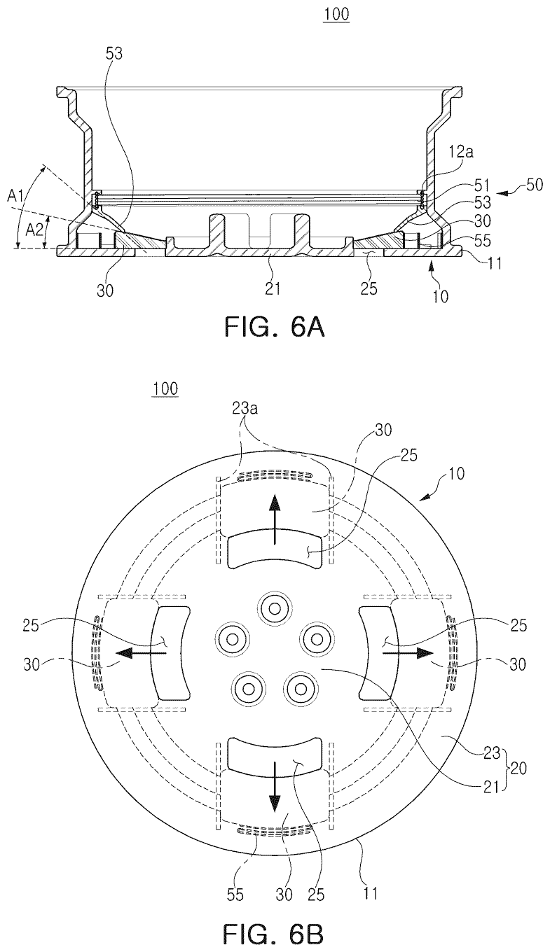

Here, in order to facilitate power transmission, a first angle A1 of a first inclined portion 53c, at which the surface of the pusher 53 is inclined with respect to the radial direction, may be provided to be greater than a second angle A2 of a second inclined portion 31, at which the surface of the sliders 30) contacting the pusher 53 is inclined with respect to the radial direction. First angle A1 and second angle A2 are shown in FIGS. 5A and 6A.

Both the push ring 51 and the pusher 53 can be provided in a circular ring shape and may move all of the sliders 30 at once.

The elastic member 55 may continuously apply force to press the sliders 30 in the direction of the hub 21. Accordingly, when power (current) is not supplied to the push ring 51, the sliders 30 may be moved toward the hub 21 and close the openings 25. In addition, when the power (current) supply is stopped, the sliders 30, which have been moved in a straight line by the push ring 51, may be returned to their original positions by the elastic force of the elastic member 55.

The elastic member 55 may be provided between an inner side of the wheel rim 10 and a radially outer end of the sliders 30.

The thickness portion 12 extending in the thickness direction is included from the surface of the wheel rim 10, and a locking protrusion 12a on which the push ring 51 is caught may be provided on the inside of the thickness portion 12. The locking protrusion 12a may be circular, and in detail, may be a circular protruding protrusion having a size corresponding to the shape of the push ring 51.

The lower end may be caught by the locking protrusion 12a in the thickness direction of the push ring 51. Accordingly, when power (current) is supplied to the push ring 51, the push ring 51 extends upwardly in the thickness direction, while the pusher 53 may be pushed upwards in the thickness direction.

A protrusion-shaped guide 23a which guides the movement of the sliders 30 may be provided on the inner surface of the spokes 23. The guide 23a may be provided to protrude and extend in a radial direction along the edge of the sliders 30. Since the sliders 30 are provided to move in the radial direction, the guide 23a may guide the radial movement of the sliders 30.

FIGS. 1 and 5A and 5B illustrate the openings 25 of the vehicle wheel 100 in a closed state according to an exemplary embodiment of the present disclosure, and FIGS. 2 and 6A and 6B illustrate the openings 25 of the vehicle wheel 100 in an open state according to an exemplary embodiment of the present disclosure.

Referring to FIGS. 1 and 5A and 5B, when power (current) is not supplied to the push ring 51 formed of shape memory alloy, the sliders 30 may be pressed toward the hub 21 so that all of the openings 25 are closed by the elastic force of the elastic member 55. The inner surface of the hub 21 may be provided with a hub protrusion 21a on which the sliders 30 pushed by the elastic member 55 is locked.

Referring to FIGS. 2 and 6A and 6B, when power (current) is supplied to the push ring 51 formed of shape memory alloy, the extension force of the push ring 51 acts as a force greater than the elastic force of the elastic member 55, so that the sliders 30 may be pressed in the thickness direction in the opposite direction of the hub 21 to open all the openings 25. Of course, the extending force of the push ring 51 may be provided larger than the sum of the elastic forces of all elastic members 55. Accordingly, the elastic member 55 may be contracted collectively, and when the extending force of the push ring 51 is removed, it may be returned and stretched collectively.

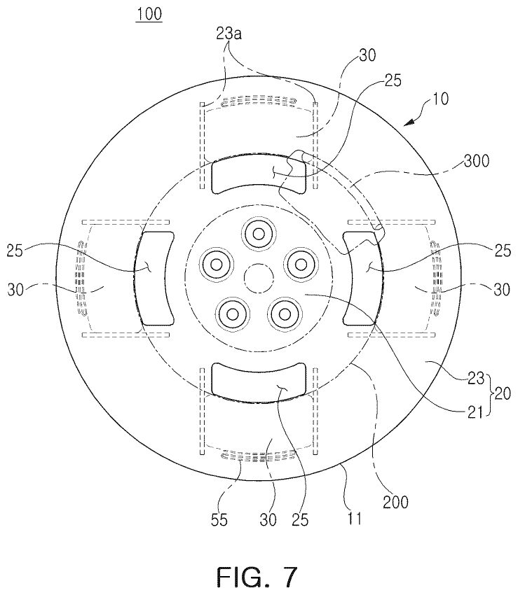

Referring to FIG. 7, a brake disc and a caliper are installed on another vehicle wheel according to an exemplary embodiment of the present disclosure.

As shown in FIG. 7, air passing through the openings 25 may serve to cool the brake disc.

In order to increase cooling efficiency, a disc brake 200 is provided on the inside of the vehicle wheel 100. The inner end of the openings 25 in the radial direction may overlap the disc brake 200 in the thickness direction, and the outer end thereof may be parallel to the outer end of the disc brake 200 in the radial direction. Also, the openings 25 may be provided to entirely overlap the disc brake 200 in the thickness direction.

According to this structure, the cooling efficiency of the disc brake 200 may be increased while the size of the openings 25 is designed to a minimum.

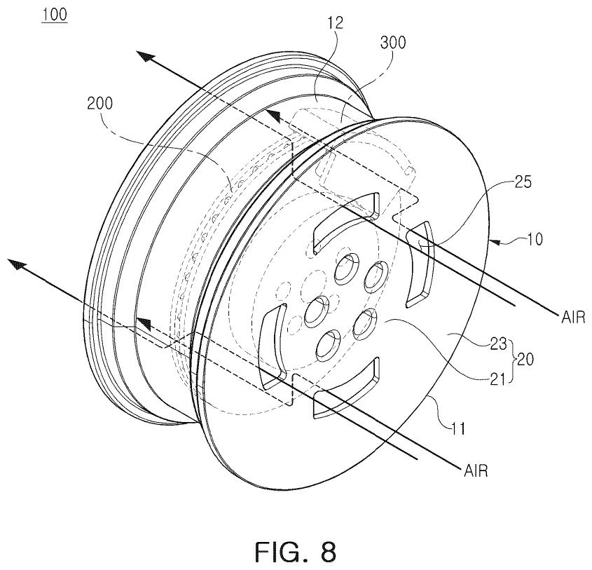

Referring to FIG. 8, an example in which air flowing along the openings 25 of a vehicle wheel 100 according to an exemplary embodiment is disclosed. Referring to the present embodiment and the structure disclosed in FIG. 7, the air flowing into the openings 25 may sufficiently cool the disc brake 200 and the caliper 300 while passing therethrough.

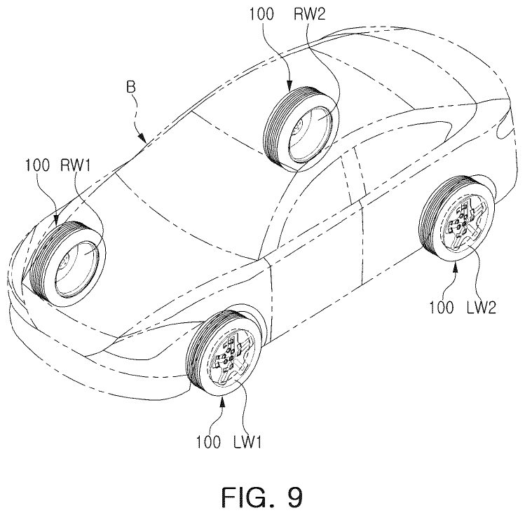

FIG. 9 is a reference diagram illustrating a vehicle on which a vehicle wheel 100 is installed according to an exemplary embodiment of the present disclosure.

The vehicle 1 according to an exemplary embodiment of the present disclosure includes at least a body B, left wheels LW-LW1, LW2, and right wheels RW-RW1, RW2 provided on the body B. In addition, the vehicle 1 of the present embodiment may include a wheel 100 having sliders 30 which may open or close the openings 25 to facilitate cooling of the brake disc during driving.

While example embodiments have been illustrated and described above, it will be apparent to those skilled in the art that modifications and variations could be made without departing from the scope of the present disclosure as defined by the appended claims.

1. A vehicle wheel comprising:
a wheel disk including a hub;
spokes extending radially from the hub;
a wheel rim positioned on a radially outward side of the spokes;
a plurality of sliders provided on the spokes, the plurality of sliders being configured to move in a radial direction to open and close a plurality of openings; and
a driving unit configured to move the plurality of sliders in a radial direction;
wherein the driving unit includes a pusher configured to move in a thickness direction of the wheel disk, wherein the thickness direction is perpendicular to the radial direction.

2. The vehicle wheel of claim 1, wherein the pusher has a ring shape.

3. The vehicle wheel of claim 2, wherein the driving unit includes a push ring formed of a shape memory alloy material which is linked to the pusher to provide a driving force for pushing the pusher in the thickness direction.

4. The vehicle wheel of claim 3, wherein the pusher includes a ring-shaped groove at an end into which the push ring is inserted.

5. The vehicle wheel of claim 1, wherein the driving unit includes an elastic member returning the plurality of sliders moved by the push ring to original positions.

6. The vehicle wheel of claim 1, wherein the driving unit includes:
the pusher moving in the direction of the wheel disk thickness and being linked to the plurality of sliders; and
a push ring formed of shape memory alloy which is linked to the pusher and provides a driving force to push the pusher in the thickness direction.

7. The vehicle wheel of claim 6, further comprising a thickness portion extending in the thickness direction from a surface of the wheel rim, and
a locking protrusion on which the push ring is locked inside the thickness portion.

8. The vehicle wheel of claim 6, wherein a surface of the pusher has an inclined cone shape, and wherein the plurality of sliders have a shape in which a surface in contact with the pusher is inclined toward the thickness direction in the radial direction.

9. The vehicle wheel of claim 8, wherein a first angle of a first slope, in which the surface of the pusher is inclined with respect to the radial direction, is greater than a second angle of a second slope, in which the surface on which the slider is in contact with the pusher is inclined with respect to the radial direction.

10. The vehicle wheel of claim 6, wherein a length of the push ring increases in the thickness direction when power is applied thereto.

11. The vehicle wheel of claim 6, wherein the driving unit includes an elastic member positioned between an inner side of the wheel rim and a radial end of the sliders.

12. The vehicle wheel of claim 11, wherein the elastic member is a leaf spring.

13. The vehicle wheel of claim 11, wherein a hub protrusion, with which the plurality of sliders pushed by the elastic member are locked, is positioned on an inner surface of the hub.

14. The vehicle wheel of claim 1, wherein a guide extending in a radial direction along an edge of the plurality of sliders, configured to guide movement of the plurality of sliders, is positioned on an inner surface of the spokes.

15. The vehicle wheel of claim 1, wherein the plurality of sliders correspond to shapes of the plurality of openings.

16. The vehicle wheel of claim 15, wherein the plurality of sliders have a larger circumferential width than the plurality of openings.

17. A vehicle comprising:
a body; and
the vehicle wheel according to claim 1, wherein the vehicle wheel is configured to enable the body to travel.

18. The vehicle of claim 17, wherein a disc brake is positioned on an inside of the vehicle wheel, and
wherein a radial outer end of the plurality of openings is parallel to a radial outer end of the disc brake, or the plurality of openings entirely overlap the disc brake.
